(19) United States
(12) Patent Application Publication
(10) Pub. No.: US 2011/0196953 A1
(43) Pub. Date: Aug. 11, 2011

(54) CONTACT MANAGER METHOD AND SYSTEM

(75) Inventor: Tareq A. Samaha, Roseville, CA (US)

(73) Assignee: TECHSTONE SOFT, INC., Roseville, CA (US)

(21) Appl. No.: 13/025,592

(22) Filed: Feb. 11, 2011

Related U.S. Application Data
(60) Provisional application No. 61/303,421, filed on Feb. 11, 2010.

(51) Int. Cl. G06F 15/173

(52) U.S. Cl. 709/223

(57) ABSTRACT

Described therein is a centralized method and system to manage contact lists among multiple mobile telephonic devices. A contact manager system resides on at least one server which is connected to a global communication network. The at least one server may communicate with a plurality of global communication network connectable mobile telephonic devices. A file repository is located at the at least one server and is used to maintain contact lists on the mobile telephonic devices. Operations which may be initiated on the contact lists include but are not limited to creation, merging, transferring, encrypting, migrating, importing, modifying. When these operations are completed, the corresponding changes are disseminated to the appropriate mobile telephonic devices.

### CROSS-REFERENCE TO RELATED APPLICATION

This application claims priority from U.S. Provisional Patent Application Ser. No. 61/303,421, entitled “Contact Manager Method and System,” filed Feb. 11, 2010, which is hereby incorporated by reference in its entirety.

### TECHNICAL FIELD

The invention relates to the fields of mobile telephonic communication and server-based global communication network services, systems and software and more specifically to the field of server-based support services for mobile telephonic devices.

### BACKGROUND

Non-provisional application Ser. No. 12/587,921, filed Oct. 14, 2009 is hereby incorporated by reference in its entirety.

Users of mobile telephonic devices such as cell phones, smart phones, cellular network connectable PDAs and other devices typically maintain a contact list on the device. The contact list contains names and telephone numbers, which are entered, accessed, edited, added to or deleted on the device and employed to initiate a call from the device in a manner known in the art.

Often, a user may have more than one such mobile telephonic device. Each telephonic device may have its own contact list, which has been populated with entries on that device. Each time a user acquires a new mobile telephonic device; a new contact list must be established and populated on that device. When decommissioning an older mobile telephonic device and acquiring a new or mobile telephonic device, a SIM card may be physically moved from the older device to the newer device, whereupon the contact list goes with the SIM card.

There exists a need for a centralized method and system to manage contact lists among multiple mobile telephonic devices.

### SUMMARY

The various embodiments of the present invention describe a contact manager system for mobile telephonic devices. Described is a method and system for providing centralized and effective ways to maintain contact lists on multiple mobile telephonic devices. The contact manager system runs on a server or a plurality of servers which are connected to a global communication network such as the Internet. The server or servers may communicate with a plurality of global communication network connectable mobile telephonic devices. The mobile telephonic devices may connect to the global communication network by accessing an Internet portal through their cellular network provider, by using a wireless router if the mobile telephonic device is a wireless network-connectable device, by a wired connection such as a USB cable to an Internet connected computer, or by other means known in the art. Client software for operating the method and system are on the server and the mobile telephonic devices.

The server has a file repository which among other things maintains files pertaining to the mobile telephonic devices. The files maintained by the file repository include, but are not limited to; contact lists, call logs, event logs. The files maintained by the file repository are also maintained on the mobile telephonic devices. Changes to the various files may be initiated from the mobile telephonic devices. The changes are recorded in the file depository and are correspondingly disseminated to appropriate mobile telephonic devices. The changes may include, creating contact lists, merging contact lists, transferring contact lists, managing encrypted contact lists, migrating contact lists, importing contact lists, modifying contact lists, etc. The contact manager system may use e-mail notification as an alert when specified events are recorded in the event log. In addition, the contact manager system may backup and restore files in the file repository. The contact manager system may use multi-factor authentication with self authentication and loop-back or closed loop authentication

### BRIEF DESCRIPTION OF THE DRAWINGS

FIG. 1 shows the major components of the contact manager system.

### DETAILED DESCRIPTION

A user of multiple mobile telephonic devices may use such a system or method to manage contact lists among the devices he or she owns. A family member may use such a system or method to coordinate contacts with a spouse or among parents and children. A business person may use such a system or method to coordinate contacts among partners or employees of the business.

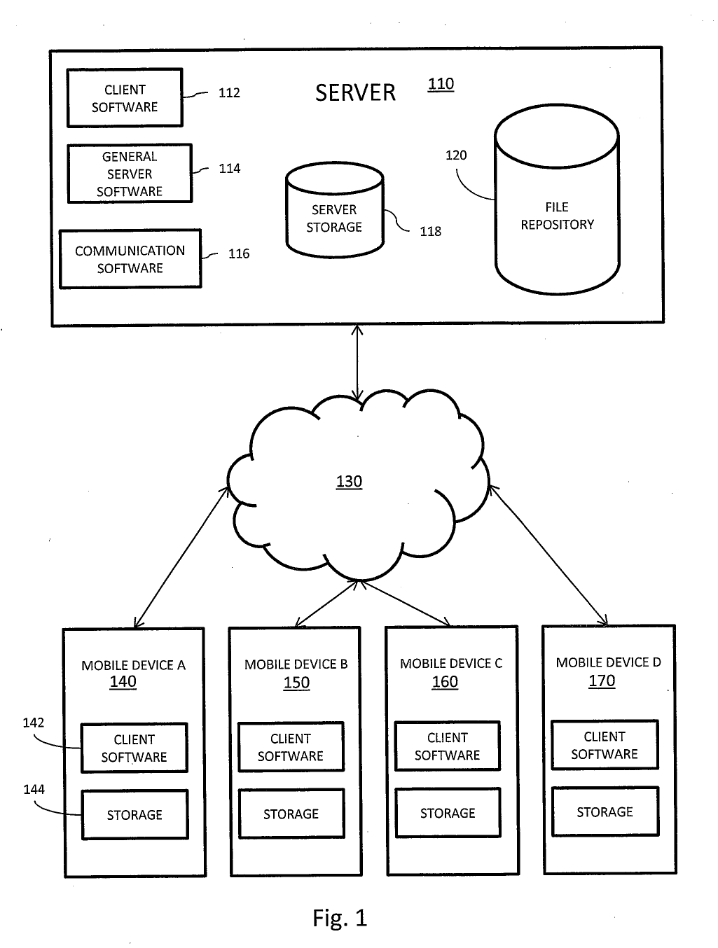

With reference to FIG. 1, a contact manager method and system are shown. The contact manager uses a server 110 connected to the global communication network 130 known as the Internet and communicating with a plurality of global communication network connectable mobile telephonic devices 140, 150, 160 and 170. The server 110 has among other things, client software 112, general server software 114, communication software 116, server storage 118, and a file repository 120. Although FIG. 1 shows four mobile telephonic devices 140, 150, 160 and 170, the system is not limited to four devices, there may be more or less than four devices. The mobile telephonic devices 140, 150, 160 and 170 may connect to the global communication network 130 by accessing an Internet portal (not shown) through the cellular network provider, by using a wireless router (not shown) if the mobile telephonic device is a wireless network-connectable device, by a wired connection (not shown) such as a USB cable to an Internet connected computer or by other means known in the art.

In the contact manager, the server 110 may be a single server, a distributed network of servers or other computing devices which can perform the disclosed services and operations. Reference to the server 110 is not limited to a single server or computing device.

The server 110 maintains files in a file repository 120, and can download files from or upload files to each of the mobile telephonic devices 140, 150, 160 and 170. File transfers, requests, notifications, queuing and other operations involving the server 110, one or more mobile telephonic devices 140, 150, 160 and 170, the file repository 120 and various connections among the mobile telephonic devices 140, 150, 160 and 170 and the server 110, are as described in the disclosed cross-referenced non-provisional application. Contact lists can be managed by a user from a global communication network connected computing device communicating with the server 110.

Using such a computing device, the user may view and select from lists of mobile telephonic devices 140, 150, 160, and 170 to which the user has authorized access. Selecting a first, a second and a third mobile telephonic device or combinations thereof, the user of the contact manager may initiate various operations which are performed using the server 110, the file repository 120 and the mobile telephonic devices 140, 150, 160 and 170. A selected mobile telephonic device may be designated an originating device, a destination device, a target device, an “A” device such as mobile device A 140, “B” device such as mobile device B 150 or given another label or identifier, or may be identified by the telephone number associated with the device. Other labels or identifiers may be devised by a person skilled in the art.

Many of the operations involve transferring a contact list, which the server 110 may accomplish by using the requests, notifications and queuing as handshaking between the server 110 and more mobile telephonic devices 140, 150, 160 and 170, as described in the disclosed related non-provisional and provisional applications. A contact list may be transferred from a mobile telephonic device to the file repository 120 or from the file repository 120 to a mobile telephonic device.

File transfers take place when the appropriate device is connected to the global communication network 130 and the server 110 confirms the connection. Thus, a user may initiate transferring or other operations applying to a contact list, while using a global communication network connected computing device, or the server 110 may schedule operations applying to a contact list, even if one or more mobile telephonic devices 140, 150, 160 and 170 are not currently connected to the global communication network 130. In an example, the server 110 will transfer a contact list from a first mobile telephonic device, such as mobile device A 140, when the first mobile telephonic device 140 connects to the global communication network 130, and will subsequently transfer a contact list to a second mobile telephonic device, such as mobile device B 150, when the second mobile telephonic device 150 connects to the global communication network 130.

A copy of one or more contact lists may be maintained by the server 110 in the file repository 120. Contact lists maintained in the file repository 120 may be given a label such as the telephone number of the device from which the contact list was originally transferred, or a label such as a master list or a numbering or lettering of lists.

With further reference to FIG. 1, migrating a contact list includes transferring the contact list from a first mobile telephonic device 140 to the file repository 120 and transferring the contact list from the file repository 120 to a second mobile telephonic device 150. The user selects the first and second mobile telephonic devices 140 and 150 from a list or separate lists of such devices, with a given list containing identifiers of devices. When the selection is complete and the action is initiated, the server 110 coordinates the file transfers among the devices and the file repository 120 as described above.

Deleting a contact from a contact list may be initiated from a computing device connected to the global communication network 130. The user selects a contact list, such as a list maintained in the file repository 120, and selects which contact to delete. The selected contact list in the file repository 120 is edited, replaced, overwritten or updated with a contact list having the selected contact deleted, by the server 110. After the contact is deleted from the contact list, the contact list may be transferred to one or more selected mobile telephonic devices 140, 150, 160 and 170, pending connection of the selected device to the global communication network 130.

Adding a contact to a contact list may be initiated from a computing device connected to the global communication network 130. The user selects a contact list, such as a list maintained in the file repository 120, and selects or enters a contact to add. A contact may be entered using a keyboard or other device or method known in the art. A contact may be selected by the user pointing to a contact from another contact list, a contact from a telephone call log, a contact in an e-mail or other message, or a contact on another list. Additional information may be entered and added to a contact selected from any of the sources. The selected contact list in the file repository 120 is edited, replaced, overwritten or updated with a contact list having the selected or entered contact added, by the server 110. After the contact is added to the contact list, the contact list may be transferred to one or more selected mobile telephonic devices 140, 150, 160 and 170, pending connection of the selected device to the global communication network 130.

Merging contact lists may be initiated from a computing device connected to the global communication network 130. The user selects a first contact list and a second contact list, such as from lists maintained in the file repository 120, and may designate a label for the merged contact list or a label may be automatically generated by the server 110. Contacts from the first list are combined with contacts from the second list, with any duplicate entries reduced to single entries, and a merged contact list is written to the file repository 120. A larger number of contact lists may be merged similarly. The merged contact list can be transferred to one or more selected mobile telephonic devices 140, 150, 160 and 170, pending connection of the selected device to the global communication network 130.

Importing a contact list may be initiated from a computing device connected to the global communication network 130. The user selects a first contact list or a first mobile telephonic device, such as mobile device A 140, from which the contact list will be imported. A second mobile telephonic device, such as mobile device B 150 is selected, to which the contact list will be imported. The option to overwrite or to merge at the second mobile telephonic device 150 is selected. For overwrite, the contact list is transferred from the first mobile telephonic device 140 to the file repository 120, and the contact list is transferred from the file repository 120 to the second mobile telephonic device 150, where the contact list from the first mobile telephonic device 140 is overwritten over the contact list resident on the second mobile telephonic device 150. For merge, the contact list is transferred from the first mobile telephonic device 140 to the file repository 120. The contact list on the second mobile telephonic device 150 may be transferred to the file repository 120, merged with the contact list from the first 140, and the merged contact list transferred to the second mobile telephonic device 150. In a further example, the contact list from the first mobile telephonic device 140 may be transferred to the file repository 120 and from the file repository 120 to the second mobile telephonic device 150, and the second mobile telephonic device 150 may merge the contact lists.

Backing up a contact list may be initiated from a computing device connected to the global communication network 130. The user selects a contact list or a mobile telephonic device from which the contact list will be backed up. The contact list is transferred by the server 110 from the mobile telephonic device to the file repository 120, pending the connection of the mobile telephonic device to the server 110 via the global communication network 130. Backing up may be initiated by user request, or scheduled on a regular basis, or may be initiated based upon an event at the mobile telephonic device. An event at the mobile telephonic device may include adding a contact to or deleting a contact from the contact lists at the mobile telephonic device.

Restoring a contact list may be initiated from a computing device connected to the global communication network 130. The user selects a contact list associated with a mobile telephonic device or selects the mobile telephonic device from a list of user devices. The contact list is transferred by the server 110 from the file repository 120 to the mobile telephonic device, pending connection of the mobile telephonic device to the global communication network 130. In order to secure the ability to restore a contact list, the system first backs up the contact list.

Deleting a contact, adding a contact or merging contact lists additionally may be initiated with one or more lists selected from one or more mobile telephonic devices 140, 150, 160 and 170, when such lists are not yet resident or maintained in the file repository 120. The server 110 coordinates transferring a selected list from a selected mobile telephonic device such as mobile device A 140 to the file repository 120, and deleting or adding a contact, or transferring another selected list from another selected mobile telephonic device such as mobile device B 150 if needed for a merged list. For example, a merge can be initiated for a contact list from more selected devices and one or more contact lists maintained in the file repository 120, or two more contact lists from selected devices, or two more contact lists maintained in the file repository 120. Various combinations may be devised by a person skilled in the art.

A call log is available from each of the mobile telephonic devices 140, 150, 160 and 170. Call information, such as a time and date stamp, the telephone number, the caller ID and associated contact information from a contact list, can be downloaded from the mobile telephonic device to the file repository 120 upon a call event, such as a call made, an incoming call, a call received, or a call missed. New call information is collected and appended to prior call information in a call log. The server 110 can maintain in the file repository 120 a separate call log for each mobile telephonic device or the server 110 may maintain a combined or merged call log with entries identifying the mobile telephonic device making or receiving the call for each call. A call log for a mobile telephonic device or a combined or merged call log may be displayed on a computing device connected to the global communication network 130, such as a computer with any browser, a set top box and television, a car computer or another phone. A selection can be made by a user, viewing a displayed call log, and the selection of the logged call applied to adding a contact to a contact list, deleting a contact from a contact list or other operations with contact information.

Notifications by e-mail can be arranged for various events occurring at a mobile telephonic device, and the events recorded in an event log maintained by the server 110 in the file repository 120. A user may elect to receive an e-mail on every request, receive an e-mail when receiving an SMS message, receive an e-mail when receiving a file, receive an e-mail when receiving a phone call, receive an e-mail when a phone call is missed, receive an e-mail when the phone status or phone state changes such as when the mobile telephonic device is turned on or off and so on.

Encryption and decryption, generation of encryption and decryption keys, exchanges of encryption and decryption keys, token generation and exchange and other security operations are managed by the server 110 in cooperation with the mobile telephonic devices 140, 150, 160 and 170. Contact lists in the file repository 120 or on mobile telephonic devices 140, 150, 160 and 170 can be in unencrypted or encrypted form. The server 110 can perform operations with or without decrypting data. For example, the server 110 can merge contacts from two or more devices having secure encrypted data without decrypting the data. Merge can be performed with or without encryption, with or without sorting and with or without indexing.

Client software may be installed on each of the mobile telephonic devices 140, 150, 160 and 170 such as client software 142 on mobile device A 140. Once installed, the client software 142 on a mobile telephonic device operates each time the device is powered up and handshakes with the server 110 via a global communication network connection. Client software 112 is installed and executes on the server 110 and handshakes with the mobile telephonic devices 140, 150, 160 and 170 as well as performing operations on files in the file repository 120 or file transfers. When a file transfer is to or from a mobile telephonic device and from or to the server 110 or the file repository 120, both the client software on the mobile telephonic device 142 and the client software 112 on the server 110 coordinate the transfer.

The contact manager system is used so that a new mobile telephonic device can be given the contacts from an existing mobile telephonic device. From a computing device connected to the server 110 via the global communication network 130 known as the Internet, a user enters the phone numbers of the existing mobile telephonic device and the new mobile telephonic device and requests the contact list be migrated from the existing device to the new device. The server 110, as part of the contact manager system, determines if the new mobile telephonic device has client software suitable for the requested operations. If not already existing, the server 110 creates the needed account, which can be temporary or permanent.

If the new mobile telephonic device does not have suitable client software, the server 110 sends a notification to the new mobile telephonic device. The notification may be an SMS (Short Message Service) message, IM (Instant Messaging) message, a voice or video message or other text or media message, and may include a link to load client software onto the new mobile telephonic device. Once the user of the new mobile telephonic device accepts the offer to load client software onto the new mobile telephonic device, the client software is installed and begins executing.

As part of the registration process for the account being set up for the new mobile telephonic device, the client software newly installed and executing on the new mobile telephonic device sends an SMS message or a phone call to itself, that is from the new mobile telephonic device to the new mobile telephonic device. This loop-back or closed loop authentication is also a multi-factor authentication and a self authentication. The SMS message includes authentication and encrypted communication information. The message loops back through the server 110 via the network 130, the server 110 interpreting the message as a notification that the registration process is underway. Upon receiving the SMS message back at the mobile telephonic device again, the registration process is completed. As the message is sent from the new mobile telephonic device to the server 110, and from the server 110 back to the new mobile telephonic device, the server 110 and the new mobile telephonic device may capture encryption and decryption keys and tokens as used for secure communication and authentication. If the returned, looped back message and any accompanying additional data, parameters or tokens are as expected back at the mobile telephonic device, the registration process is considered complete, access is allowed, and further processes may commence. Such parameters may include IMEI device ID, IMSI SIM card ID, ESN device ID equivalent to IMEI but for CDMA, or a MAC address for wireless communications, an OS (Operating System) ID, a ROM ID, a TPM module, certificate information, hardware or software parameters. These parameters could be previously known and in a database or storage 118 accessible to the server 110 or storage 144 on the mobile telephonic device. Secure communications keys, tokens or parameters can be stored for future communications or deleted after a one-time operation. In one example, once the client software 142 is installed, the client software 142 runs, authenticates and completes the registration with no further user interaction.

The authentication type can be selectable. The user may be asked to validate or enter a phone number, username, password or other parameters, to complete the registration.

Next, whether the new mobile telephonic device had previously installed client software or has currently completed loading of client software and begun executing, the new mobile telephonic device is ready for the contact list migration. As described above, the server 110 coordinates a transfer of the contact list from the existing mobile telephonic device to the file repository 120, if the contact list does not already have a copy in the file repository 120 and a transfer of the contact list from the file repository 120 to the new mobile telephonic device. As contacts are added to either the new mobile telephonic device or the existing mobile telephonic device, the system may prompt for a backup of the respective contact list. In a further example, the system schedules a backup of the contact list at regular intervals or based upon an event: The system can back up the contact list automatically when a contact is added to a list, without prompting the user: Encryption and decryption can be applied for secure communication. The contact list can be transferred in encrypted form, without being decrypted in the file repository 120, or the contact list can be transferred from the existing mobile telephonic device in encrypted form, decrypted in the file repository 120, then re-encrypted and transferred from the file repository 120 to the new mobile telephonic device.

The contact manager provides a method and system for managing contacts and contact lists among multiple mobile communication devices via a global communication network 130 connected server 110 using a file repository 120. The contact manager includes services for transferring, merging, restoring, adding a contact to or deleting a contact from contact lists, and a multi-factor authentication with self authentication and loop-back or closed loop authentication. Secure communication may be used and contact lists managed with or without encryption.

What is claimed is:

1. A contact manager system comprising:
a global communication network connectable server; and
a plurality of global communication network connectable mobile communication devices; wherein
the server manages contact lists associated with the communication devices.

2. The contact manager system of claim 1 wherein the server manages contact lists includes merging contact lists.

3. The contact manager system of claim 1 wherein the server manages contact lists includes transferring contact lists.

4. The contact manager system of claim 1 wherein the server manages contact lists includes managing encrypted contact lists.

5. The contact manager system of claim 1 wherein the server manages contact lists includes migrating contact lists.

6. The contact manager system of claim 1 wherein the server manages contact lists includes importing contact lists.

7. The contact manager system of claim 1 further including e-mail notifications.

8. The contact manager system of claim 1 further including closed loop authentication.
